(19) United States
(12) Patent Application Publication
(10) Pub. No.: US 2013/0022814 A1
(43) Pub. Date: Jan. 24, 2013

(54) Wooden Newel Post Material

(71) Applicant: Kuan-Hung Lin, Tainan City (TW)

(72) Inventor: Kuan-Hung Lin, Tainan City (TW)

(21) Appl. No.: 13/185,645

(22) Filed: Jul. 19, 2011

(51) Int. Cl. B32B 21/13

(52) U.S. Cl. 428/397

(57) ABSTRACT

A wooden Newel post material includes two outer boards made. A middle board includes two outer sections and a central section between the outer sections and having a plurality of portions. The uppermost portion of the central section, the outer boards, and the outer sections of the middle board are made of the same high-quality wood. The remaining portions below the uppermost portion of the central section are made of short waste material resulting from cutting a wood the same as the high-quality wood or made of a second-grade wood. The plurality of portions is fixedly engaged with each other to form the central section. The central section is fixedly engaged with the outer sections to form the middle board. The middle board is sandwiched between the outer boards to form a base material that can be cut to form a baluster representing an appearance of the high-quality wood.

### BACKGROUND OF THE INVENTION

The present invention relates to a wooden newel post material and, more particularly, to a wooden newel post material for reducing the waste of wood resources while providing an appearance with enhanced visual quality.

A Newel post made of high-quality wood can provide enhanced architectural aesthetics. FIG. 6 shows a conventional Newel post material including three elongated boards 11′, 12′ and 13′ obtained by cutting high-quality wood, such as oak, maple, ash, etc. The boards 11′, 12′, and 13′ are bonded by adhesive to form a column-like base material 1′. The base material 1′ is then turning by a machine to form a Newel post having a desired shape. Since the base material 1′ is completely made of high-quality wood, the appearance of the Newel post after turning represents a high-quality pattern and visual quality. However, the Newel Post completely made of high-quality wood results in significant consumption of wood resources and is not eco-friendly while increasing the costs of the Newel Post

### BRIEF SUMMARY OF THE INVENTION

An objective of the present invention is to provide a wooden Newel post material capable of reducing the waste of wood resources while providing an appearance with enhanced visual quality.

A wooden Newel post material according to the present invention includes two outer boards made of a high-quality wood and each being a parallelepiped. A middle board includes two outer sections and a central section. The outer sections are made of a wood the same as the high-quality wood. The central section is located between the outer sections and includes a plurality of portions. The uppermost portion of the central section is made of a wood the same as the high-quality wood. The remaining portions below the uppermost portion of the central section are made of short waste materials resulting from cutting a wood the same as the high-quality wood or made of a second-grade wood obtained by artificial cultivation. The plurality of portions is fixedly engaged with each other to form the central section. The central section is fixedly engaged with the outer sections to form the middle board. The middle board is sandwiched between the outer boards to form a base material. The base material is adapted to be turned to form a Newel post having a top end and a plurality of sides. The top end and the sides of the Newel post represent an appearance of the high-quality wood.

Preferably, the outer boards are made of oak, maple, poplar, alder, or beech.

Preferably, each outer board is a parallelepiped and includes a longer side and a shorter side that are parallel to the ground. The middle board includes a longer side and a shorter side that are parallel to the ground. The shorter side of the middle board is located between the shorter sides of the outer boards. Mutually facing sides of the middle board and the outer boards are bonded together by adhesive to form an elongated base material having substantially square cross sections.

Preferably, the short waste materials for each of the portions of the central section below the uppermost portion of the central section are bonded together to form a laminated material.

Preferably, two adjacent portions of the central section include a lower serrated coupling section and an upper serrated coupling section bonded by adhesive to the lower serrated coupling section.

The present invention will become clearer in light of the following detailed description of illustrative embodiments of this invention described in connection with the drawings.

### DESCRIPTION OF THE DRAWINGS

FIG. 1 shows a perspective view of a wooden Newel post material according to the present invention.

FIG. 2 shows a partial, exploded, perspective view of a middle board of the wooden Newel post material of FIG. 1.

FIG. 3 shows a partial, exploded, perspective view of the middle board and two outer boards of the wooden Newel post material of FIG. 1.

FIG. 4 shows a cross sectional view of the wooden Newel post material of FIG. 3. FIG. 5 shows a cross sectional view similar to FIG. 3, with the wooden Newel post material turn to form a Newel post.

FIG. 6 shows a perspective view of a conventional base material for a Newel post.

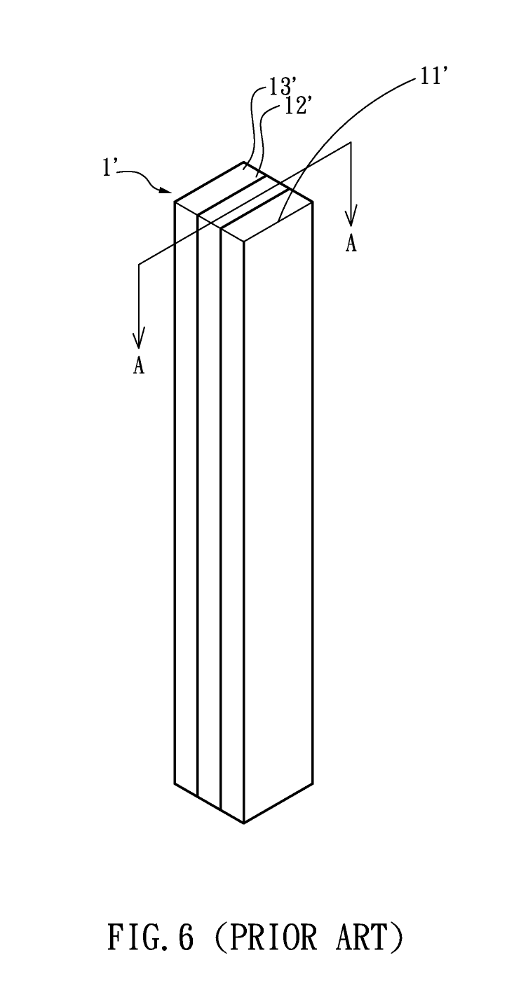

FIG. 7 shows a cross sectional view of the conventional base material of FIG. 6 taken along section line A-A of FIG. 6, with the base material turn to form a Newel post.

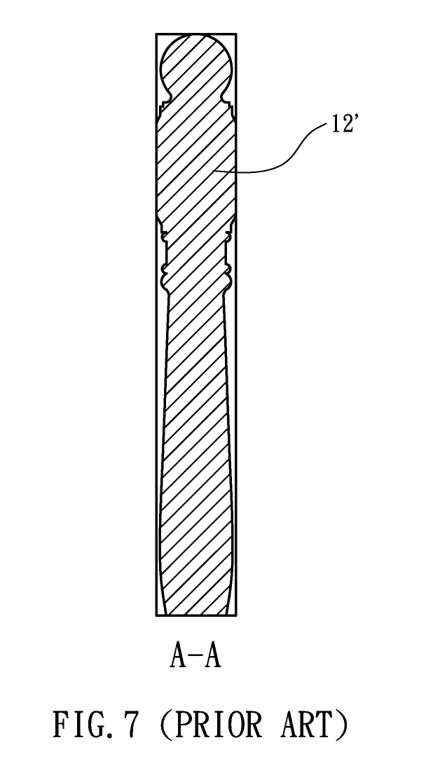

### DETAILED DESCRIPTION OF THE INVENTION

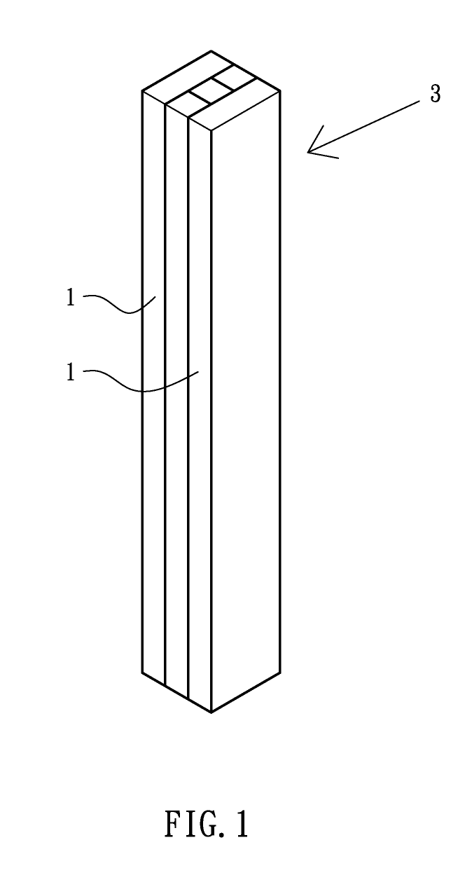

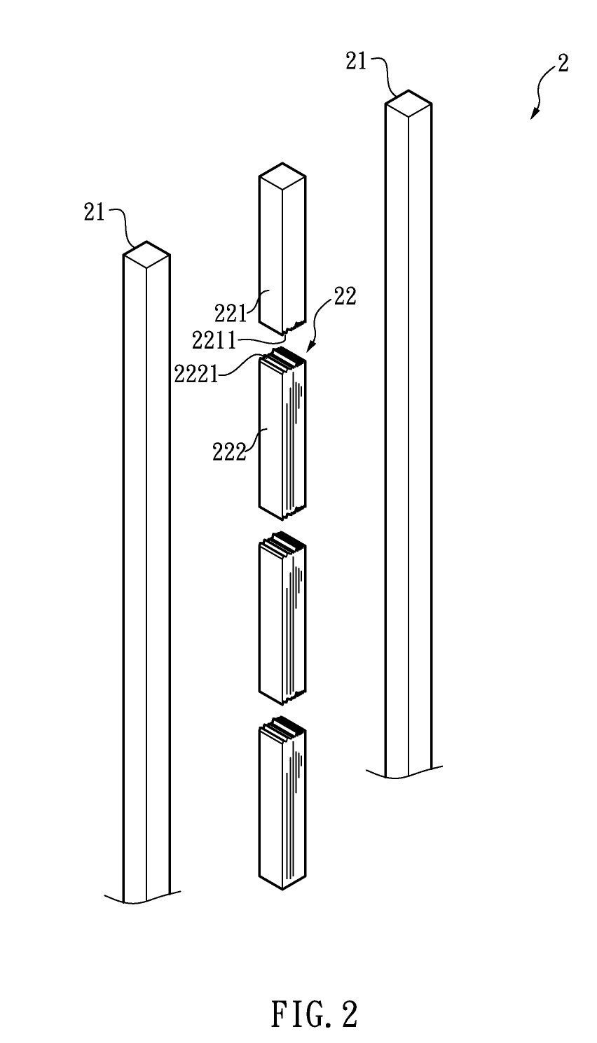

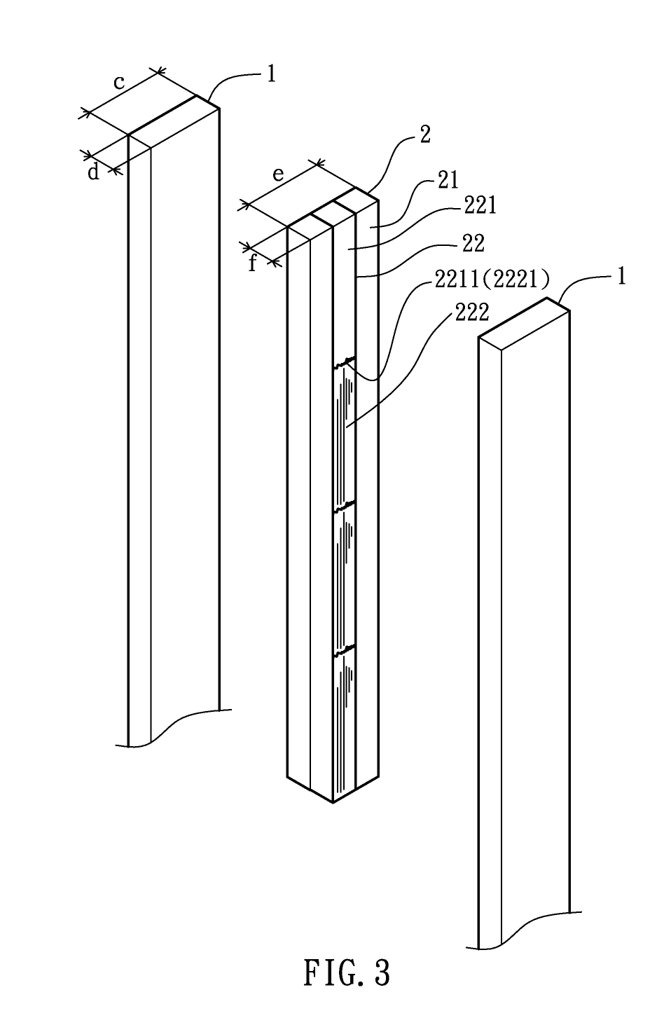

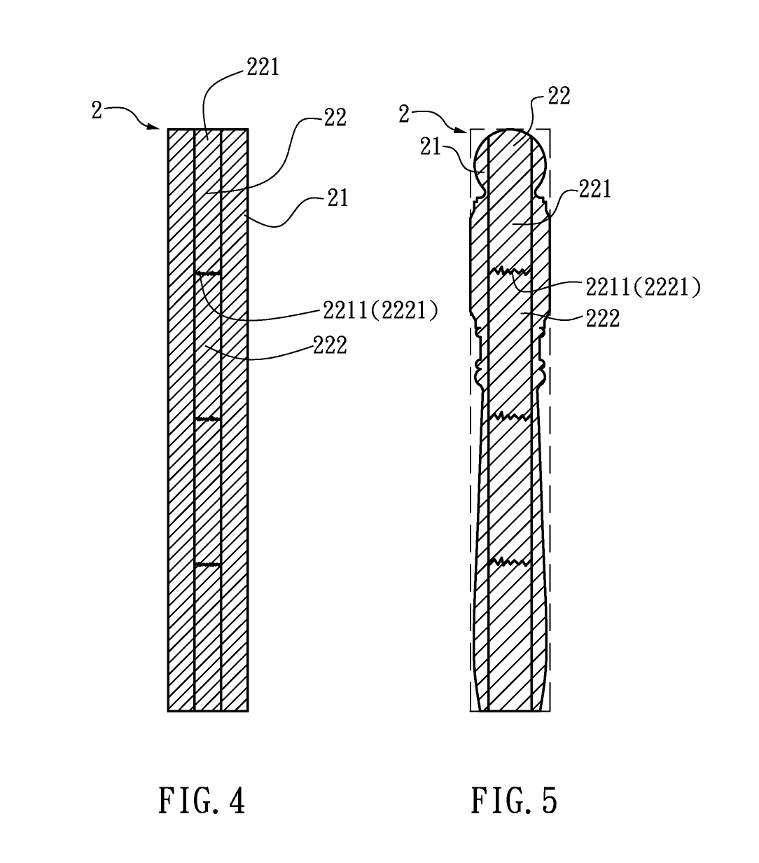

With reference to FIGS. 1-4, a wooden Newel post material according to the present invention includes two outer boards 1 and a middle board 2 between the outer boards 1. Each outer board 1 is parallelepiped and includes a longer side c and a shorter side d that are parallel to the ground. The outer boards 1 are made of a high-quality wood, such as oak, maple, poplar, alder, or beech.

The middle board 2 includes two outer sections 21 and a central section 22. Each of the outer sections 21 is a parallelepiped and is made of a high-quality wood the same as that for the outer boards 1. The central section 22 is located between the outer sections 21 and includes a plurality of portions. The uppermost portion 221 of the central section 21 is a parallelepiped and is made of a high-quality wood the same as that for the outer boards 1. Lower portions 222 below the uppermost portion 221 are made of short waste material resulting from cutting a high-quality wood the same as that for the outer boards 1 or made of a second-grade wood obtained by artificial cultivation. The short waste materials for each lower portion 222 are compressed to form a laminated material in the form of a parallelepiped. Two adjacent portions 221, 222 of the central section 22 include a lower serrated coupling section 2211 and an upper serrated coupling section 2221. Each of the lower serrated coupling section 2211 is bonded by adhesive to a corresponding upper serrated coupling section 2221. Thus, the uppermost portion 221 and the lower portions 222 can be bonded together by adhesive and then compressed to form a parallelepiped having a length corresponding to that of the outer boards 21. The serrated lower coupling section 2211 of the uppermost portion 221 and the upper serrated coupling section 2221 below the uppermost portion 221 provide reliable engagement. Likewise, two adjacent lower portions 222 are reliably bonded together through provision of the serrated lower and upper coupling sections 2211 and 2221. The central section 22 is sandwiched between the outer sections 21, and adhesive is applied to mutually facing sides of the central section 22 and the outer sections 21. Next, the central section 22/outer sections 21 are compressed to form the middle board 2 in the form of a parallelepiped. The middle board 2 includes a longer side e and a shorter side f that are parallel to the ground. The shorter side f of the middle board 2 is located between the shorter sides d of the two outer boards 1. Adhesive is applied to mutually faced sides of the middle board 2 and the outer boards 1. The middle board 2/outer boards 1 are then compressed to form an elongated base material 3 having substantially square cross sections. A lower end of the lowest portion 222 made of shorter waste material is exposed out of a bottom of the base material 3. The remaining portions 221 and 222 above the lowest portion 222 of the middle board 2 are not exposed.

With reference to FIGS. 1 and 5, the surface of the base material 3 can be turn to form a Newel post having a desired shape. When cutting the middle board 2, only the outer sections 21 and the uppermost portion 221 are turned. Since the lower end of the lowest portion 222 is covered when the Newel post is mounted on the ground, the surface of the Newel post after turning can still represent a high-quality pattern and visual quality. Since the Newel post material according to the present invention uses short waste material or an inexpensive second-grade wood, the consumption of natural forest resources can be reduced while providing environmental protection.

In a case that the lower portions 222 of the middle board 2 are made of a material the same as that of the outer boards 1, enhanced bonding effect is provided, because the wood materials for the middle boards 2 and the outer boards 1 have the same density and the same pores. Thus, breaking resulting from heat expansion/cold shrinkage is less likely to occur when the temperature changes.

The outer boards 1 and the middle board 2 do not have to be parallelepipeds. The outer boards and the middle board 2 can have any shape that can be turned to form high-quality Newel post.

Although specific embodiments have been illustrated and described, numerous modifications and variations are still possible without departing from the essence of the invention. The scope of the invention is limited by the accompanying claims.

1. A wooden Newel post material comprising:
two outer boards made of a high-quality wood and each being a parallelepiped; and
a middle board including two outer sections and a central section, with the two outer sections made of a wood the same as the high-quality wood, with the central section located between the two outer sections and including a plurality of portions, with an uppermost one of the plurality of portions of the central section made of a wood the same as the high-quality wood, with remaining portions below the uppermost portion of the central section made of short waste material resulting from cutting a wood the same as the high-quality wood or made of a second-grade wood obtained by artificial cultivation, with the plurality of portions fixedly engaged with each other to form the central section, with the central section fixedly engaged with the two outer sections to form the middle board, with the middle board sandwiched between the two outer boards to form a base material, with the base material adapted to be cut to form a Newel post having a top end and a plurality of sides, with the top end and the plurality of sides of the Newel post representing an appearance of the high-quality wood.

2. The wooden Newel post material as claimed in claim 1, with the outer boards made of one of oak, maple, poplar, alder, and beech.

3. The wooden Newel post material as claimed in claim 1, with each of the two outer boards including a longer side and a shorter side that are parallel to a ground, with the middle board including a longer side and a shorter side that are parallel to the ground, with the shorter side of the middle board located between the shorter sides of the two outer boards, with mutually facing sides of the middle board and the two outer boards bonded together by adhesive to form an elongated base material having substantially square cross sections.

4. The wooden Newel post material as claimed in claim 1, with the short waste materials for each of the portions of the central section below the uppermost portion of the central section being bonded together to form a laminated material.

5. The wooden Newel post material as claimed in claim 4, with two adjacent portions of the central section including a lower serrated coupling section and an upper serrated coupling section, with each of the lower serrated coupling section bonded by adhesive to a corresponding upper serrated coupling section to bond two adjacent portions together.
